(19) United States
(12) Patent Application Publication
(10) Pub. No.: US 2025/0124333 A1
(43) Pub. Date: Apr. 17, 2025

(54) METHOD AND SYSTEM FOR REMOVING DEFICIENCIES FROM A DATASET

(71) Applicant: JPMorgan Chase Bank, N.A., New York, NY (US)

(72) Inventors: Deepak PARAMANAND, Middlesex (GB); Tucker Richard BALCH, Suwanee, GA (US)

(73) Assignee: JPMorgan Chase Bank, N.A., New York, NY (US)

(21) Appl. No.: 18/379,403

(22) Filed: Oct. 12, 2023

(51) Int. Cl. G06N 20/00

(52) U.S. Cl. CPC G06N 20/00

(57) ABSTRACT

A system for removing deficiencies from a dataset. The system may include a processor and memory that stores instructions that, when executed by the processor, cause the processor to perform operations. The operations may include removing deficiencies from a dataset that may have been obtained via an input of the synthetic training data generation tool. The removing of deficiencies from the dataset may comprise: determining that the dataset includes training deficiencies; retrieving, from one or more data sources, first remediating data that rectifies a first deficiency; rectifying the first deficiency by updating the dataset with the first remediating data; determining that the updated dataset still includes a training deficiency; and synthesizing second remediating data that rectifies the training deficiency.

### BACKGROUND

### 1. Field of the Invention

The field of the invention disclosed herein generally relates to a system for removing deficiencies from a dataset and, more particularly, to a method, system, and computer-readable storage medium for implementing technology for a synthetic training data generation tool that removes deficiencies that exist within a training dataset.

### 2. Background of the Invention

In the technological field of artificial intelligence and machine learning (AI/ML), the phrase “training data” refers to a set of examples (or information) that is utilized to train one or more AI/ML models. However, it is important to note that in this technological field, the quality of the data utilized to train an AI/ML model is crucial to the model's performance.

For example, due to the nature of the technology, AI/ML models generally inherit biases that exist within the training datasets on which they were trained. Therefore, a crucial drawback of an incomplete training dataset—or a dataset that otherwise suffers from one or more such training deficiencies (e.g., gaps, biases, etc.)—is that such a dataset produces AI/ML models that suffer from its same (or corresponding) deficiencies.

Accordingly, in order to produce more useful models, there is a need in the technological field of AI/ML for a technical solution to this drawback of a training dataset whose quality falls below a threshold that is required to ensure that the AI/ML model to which the training dataset pertains is reliable for its intended purpose(s) and/or application(s).

### SUMMARY

The present disclosure, through one or more of its various aspects, embodiments, and/or specific features or sub-component, provides, inter alia, various systems, servers, devices, methods, media, programs and platforms for implementing a system for removing deficiencies that exist within a training dataset by tuning the training dataset according to an artificial intelligence and machine learning (AI/ML) model to which the training dataset pertains.

According to an aspect of the present disclosure, a method is provided for removing deficiencies from a dataset. The method may comprise: obtaining, via an input of the synthetic training data generation tool, a first training dataset; and removing deficiencies from the first training dataset. The removing the deficiencies may comprise: determining that the first training dataset includes a first set of training deficiencies; retrieving, from at least one data source, first remediating data that rectifies a first deficiency from among the first set of training deficiencies; rectifying the first deficiency by combining the first training dataset with the first remediating data to produce a first updated training dataset that comprises the first training dataset and the first remediating data; determining that the first updated training dataset includes a second set of training deficiencies; and synthesizing second remediating data that rectifies a second deficiency from the second set of training deficiencies. The first remediating data may comprise real-world data, and the second set of training deficiencies may comprise at least one from among a first new set of deficiencies and a subset of the first set of training deficiencies.

In the method, the first set of training deficiencies may comprise at least one from among: a set of new training data, a set of incomplete training data, a set of missing training data, a set of irregular data, a set of training biases, and a set of unavailable hypothetical scenario data.

In the method, the synthesizing may comprise utilizing at least one from among an interpolation and an extrapolation to produce a first refined training dataset from the first updated training dataset; and the first refined training dataset may comprise the first training dataset, the first remediating data, and the second remediating data.

In the method, the removing the deficiencies may further comprise: determining that the first refined training dataset includes a third set of training deficiencies; generating third remediating data that rectifies a third deficiency from the third set of training deficiencies; and rectifying the third deficiency by integrating the third remediating data into the first refined training dataset to produce a first synthesized training dataset that comprises the first refined training dataset and the third remediating data. The third set of training deficiencies may comprise at least one from among a second new set of deficiencies and a subset of the second set of training deficiencies.

In the method, the generating the third remediating data may comprise: mimicking a set of characteristics from a set of existing data. The set of characteristics may comprise at least one from among: user selected characteristics; and characteristics of a similar dataset that has more attributes in common with the third remediating data than another available set of data has in common with the third remediating data.

In the method, the set of characteristics may comprise at least one from among a set of values from the first training dataset, a set of statistical features of the first training dataset, and a distribution of the first training dataset.

In the method, the removing the deficiencies may further comprise: determining that the first synthesized training dataset includes a fourth set of training deficiencies; generating fourth remediating data that rectifies a fourth deficiency from the fourth set of training deficiencies; and rectifying the fourth deficiency by integrating the fourth remediating data into the first synthesized training dataset to produce a second synthesized training dataset that comprises the first synthesized training dataset and the fourth remediating data. The fourth set of training deficiencies may comprise at least one from among a third new set of deficiencies and a subset of the third set of training deficiencies.

In the method, the method may further comprise: utilizing at least one from among the first training dataset, the first updated training dataset, the first refined training dataset, the first synthesized training dataset, and the second synthesized training dataset, to train a first artificial intelligence and machine learning (AI/ML) model; evaluating the first AI/ML model to identify a fifth set of training deficiencies from a first performance of the first AI/ML model; and upon identifying the fifth set of training deficiencies, repeating the removing the deficiencies in order to remove the fifth set of training deficiencies from the at least one from among the first training dataset, the first updated training dataset, the first refined training dataset, the first synthesized training dataset, and the second synthesized training dataset.

In the method, the generating the fourth remediating data may comprise: utilizing at least one from among a random number generator; user settings; and a second AI/ML model, to produce the fourth remediating data.

In the method, the method may further comprise: continuously monitoring the input to identify a subsequent dataset that includes a sixth set of training deficiencies; and upon identifying the subsequent dataset, repeating the removing the deficiencies in order to remove the sixth set of training deficiencies from the subsequent dataset.

According to another aspect of the present disclosure, a system for removing deficiencies from a dataset. The system may comprise: a processor; and memory storing instructions that, when executed by the processor, cause the processor to perform operations. The operations may comprise: obtaining, via an input of the synthetic training data generation tool, a first training dataset; and removing deficiencies from the first training dataset. The removing the deficiencies may comprise: determining that the first training dataset includes a first set of training deficiencies; retrieving, from at least one data source, first remediating data that rectifies a first deficiency from among the first set of training deficiencies; rectifying the first deficiency by combining the first training dataset with the first remediating data to produce a first updated training dataset that comprises the first training dataset and the first remediating data; determining that the first updated training dataset includes a second set of training deficiencies; and synthesizing second remediating data that rectifies a second deficiency from the second set of training deficiencies. The first remediating data may comprise real-world data, and the second set of training deficiencies may comprise at least one from among a first new set of deficiencies and a subset of the first set of training deficiencies.

In the system, the first set of training deficiencies may comprise at least one from among: a set of new training data, a set of incomplete training data, a set of missing training data, a set of irregular data, a set of training biases, and a set of unavailable hypothetical scenario data.

In the system, the synthesizing may comprise utilizing at least one from among an interpolation and an extrapolation to produce a first refined training dataset from the first updated training dataset; and the first refined training dataset may comprise the first training dataset, the first remediating data, and the second remediating data.

In the system, the removing the deficiencies may further comprise: determining that the first refined training dataset includes a third set of training deficiencies; generating third remediating data that rectifies a third deficiency from the third set of training deficiencies; and rectifying the third deficiency by integrating the third remediating data into the first refined training dataset to produce a first synthesized training dataset that comprises the first refined training dataset and the third remediating data. The third set of training deficiencies may comprise at least one from among a second new set of deficiencies and a subset of the second set of training deficiencies.

In the system, the generating the third remediating data may comprise: mimicking a set of characteristics from a set of existing data. The set of characteristics may comprise at least one from among: user selected characteristics; and characteristics of a similar dataset that has more attributes in common with the third remediating data than another available set of data has in common with the third remediating data.

In the system, the set of characteristics may comprise at least one from among a set of values from the first training dataset, a set of statistical features of the first training dataset, and a distribution of the first training dataset.

In the system, the removing the deficiencies may further comprise: determining that the first synthesized training dataset includes a fourth set of training deficiencies; generating fourth remediating data that rectifies a fourth deficiency from the fourth set of training deficiencies; and rectifying the fourth deficiency by integrating the fourth remediating data into the first synthesized training dataset to produce a second synthesized training dataset that comprises the first synthesized training dataset and the fourth remediating data. The fourth set of training deficiencies may comprise at least one from among a third new set of deficiencies and a subset of the third set of training deficiencies.

In the system, when executed by the processor, the instructions may cause the processor to perform further operations. The further operations may comprise: utilizing at least one from among the first training dataset, the first updated training dataset, the first refined training dataset, the first synthesized training dataset, and the second synthesized training dataset, to train a first artificial intelligence and machine learning (AI/ML) model; evaluating the first AI/ML model to identify a fifth set of training deficiencies from a first performance of the first AI/ML model; and upon identifying the fifth set of training deficiencies, repeating the removing the deficiencies in order to remove the fifth set of training deficiencies from the at least one from among the first training dataset, the first updated training dataset, the first refined training dataset, the first synthesized training dataset, and the second synthesized training dataset.

In the system, the generating the fourth remediating data may comprise: utilizing at least one from among a random number generator; user settings; and a second AI/ML model, to produce the fourth remediating data.

In the system, when executed by the processor, the instructions may cause the processor to perform further operations. The further operations may comprise: continuously monitoring the input to identify a subsequent dataset that includes a sixth set of training deficiencies; and upon identifying the subsequent dataset, repeating the removing the deficiencies in order to remove the sixth set of training deficiencies from the subsequent dataset.

According to yet a further aspect of the present disclosure, a non-transitory computer-readable medium for removing deficiencies from a dataset. The computer-readable medium storing instructions that, when executed by a processor, cause the processor to perform operations. The operations may comprise: obtaining, via an input of the synthetic training data generation tool, a first training dataset; and removing deficiencies from the first training dataset. The removing the deficiencies may comprise: determining that the first training dataset includes a first set of training deficiencies; retrieving, from at least one data source, first remediating data that rectifies a first deficiency from among the first set of training deficiencies; rectifying the first deficiency by combining the first training dataset with the first remediating data to produce a first updated training dataset that comprises the first training dataset and the first remediating data; determining that the first updated training dataset includes a second set of training deficiencies; and synthesizing second remediating data that rectifies a second deficiency from the second set of training deficiencies. The first remediating data may comprise real-world data, and the second set of training deficiencies may comprise at least one from among a first new set of deficiencies and a subset of the first set of training deficiencies.

In the computer-readable medium, the first set of training deficiencies may comprise at least one from among: a set of new training data, a set of incomplete training data, a set of missing training data, a set of irregular data, a set of training biases, and a set of unavailable hypothetical scenario data.

In the computer-readable medium, the synthesizing may comprise utilizing at least one from among an interpolation and an extrapolation to produce a first refined training dataset from the first updated training dataset; and the first refined training dataset may comprise the first training dataset, the first remediating data, and the second remediating data.

In the computer-readable medium, the removing the deficiencies may further comprise: determining that the first refined training dataset includes a third set of training deficiencies; generating third remediating data that rectifies a third deficiency from the third set of training deficiencies; and rectifying the third deficiency by integrating the third remediating data into the first refined training dataset to produce a first synthesized training dataset that comprises the first refined training dataset and the third remediating data. The third set of training deficiencies may comprise at least one from among a second new set of deficiencies and a subset of the second set of training deficiencies.

In the computer-readable medium, the generating the third remediating data may comprise: mimicking a set of characteristics from a set of existing data. The set of characteristics comprises at least one from among: user selected characteristics; and characteristics of a similar dataset that has more attributes in common with the third remediating data than another available set of data has in common with the third remediating data.

In the computer-readable medium, the set of characteristics may comprise at least one from among a set of values from the first training dataset, a set of statistical features of the first training dataset, and a distribution of the first training dataset.

In the computer-readable medium, the removing the deficiencies may further comprise: determining that the first synthesized training dataset includes a fourth set of training deficiencies; generating fourth remediating data that rectifies a fourth deficiency from the fourth set of training deficiencies; and rectifying the fourth deficiency by integrating the fourth remediating data into the first synthesized training dataset to produce a second synthesized training dataset that comprises the first synthesized training dataset and the fourth remediating data. The fourth set of training deficiencies may comprise at least one from among a third new set of deficiencies and a subset of the third set of training deficiencies.

In the computer-readable medium, when executed by the processor, the instructions may cause the processor to perform further operations. The further operations may comprise: utilizing at least one from among the first training dataset, the first updated training dataset, the first refined training dataset, the first synthesized training dataset, and the second synthesized training dataset, to train a first artificial intelligence and machine learning (AI/ML) model; evaluating the first AI/ML model to identify a fifth set of training deficiencies from a first performance of the first AI/ML model; and upon identifying the fifth set of training deficiencies, repeating the removing the deficiencies in order to remove the fifth set of training deficiencies from the at least one from among the first training dataset, the first updated training dataset, the first refined training dataset, the first synthesized training dataset, and the second synthesized training dataset.

In the computer-readable medium, the generating the fourth remediating data comprises: utilizing at least one from among a random number generator; user settings; and a second AI/ML model, to produce the fourth remediating data.

In the computer-readable medium, when executed by the processor, the instructions cause the processor to perform further operations. The further operations may comprise: continuously monitoring the input to identify a subsequent dataset that includes a sixth set of training deficiencies; and upon identifying the subsequent dataset, repeating the removing the deficiencies in order to remove the sixth set of training deficiencies from the subsequent dataset.

Thereby, the invention disclosed herein improves existing technology by providing a synthetic training data generation tool that removes deficiencies that exist within a training dataset by tuning the training dataset according to an AI/ML model to which the training dataset pertains.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 is a diagram of an exemplary computer system.

FIG. 2 is a diagram of an exemplary network environment that implements a synthetic training data generation tool.

FIG. 3 is a diagram of an exemplary perspective of a network environment that utilizes a synthetic training data generation tool to remove one or more deficiencies that exist within a training dataset.

FIG. 4 is a flowchart of an exemplary process for removing deficiencies from a dataset that removes deficiencies that exist within a training dataset.

FIG. 5 depicts a training dataset and a pair of remediating datasets that each remove at least one deficiency that exists within the training dataset.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable storage media having instructions stored thereon for one or more aspects of the present technology as described and illustrated by way of the examples herein. In some examples, the instructions include executable code that, when executed by one or more processors, cause the processors to carry out steps necessary to implement the methods of the examples of this technology that are described and illustrated herein.

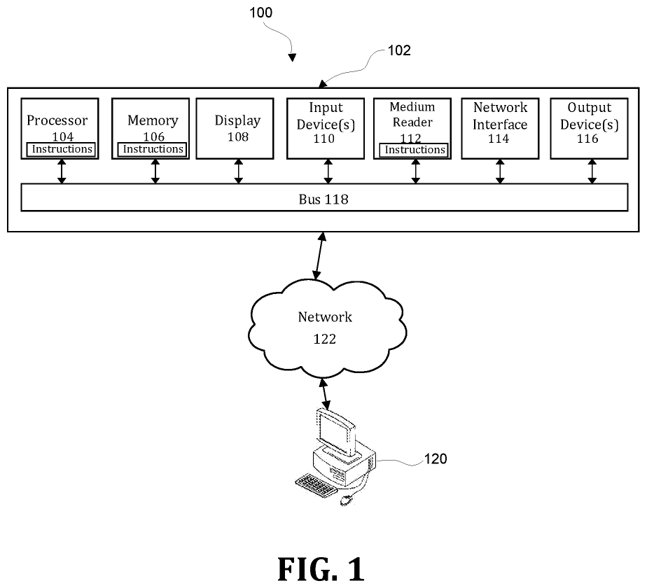

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide methods and systems for removing deficiencies from a dataset that rectifies deficiencies that exist within a training dataset.

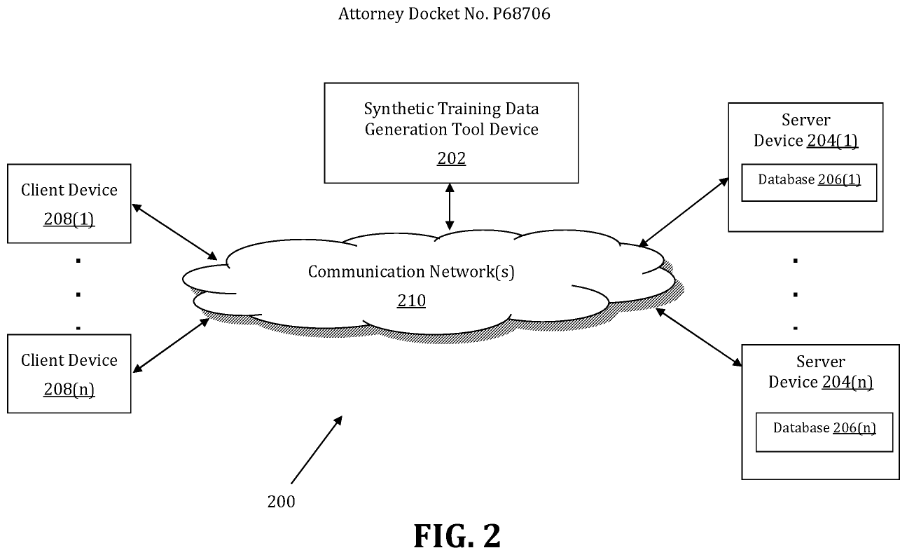

Referring to FIG. 2, a schematic of an exemplary network environment 200 an exemplary network environment that implements a Synthetic Training Data Generation Tool, is illustrated. In an exemplary embodiment, the Synthetic Training Data Generation Tool may be implemented on any networked computer platform, such as, for example, a personal computer (PC).

A method for implementing technology for values-based decision-making, diagnostics, and reporting may be implemented by a Synthetic Training Data Generation Tool (STDGT) device 202. The STDGT device 202 may be the same or similar to the computer system 102 as described with respect to FIG. 1. The STDGT device 202 may be a rack-mounted server in a datacenter, an embedded microcontroller (MCU) in an electronic device, or another type of headless system, which is a computer system or device that is configured to operate without a monitor, keyboard and mouse. The STDGT device 202 may store one or more applications that can include executable instructions that, when executed by the STDGT device 202, cause the STDGT device 202 to perform actions, such as to transmit, receive, or otherwise process network communications, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the STDGT device 202 itself, may be located in virtual server(s) running in a cloud-based computing environment rather than being tied to one or more specific physical network computing devices. Also, the application(s) may be running in one or more virtual machines (VMs) executing on the STDGT device 202. Additionally, in one or more embodiments of this technology, virtual machine(s) running on the STDGT device 202 may be managed or supervised by a hypervisor.

In the network environment 200 of FIG. 2, the STDGT device 202 is coupled to a plurality of server devices 204(1)-204(n) that hosts a plurality of repositories and/or databases 206(1)-206(n), and also to a plurality of client devices 208(1)-208(n) via communication network(s) 210. A communication interface of the STDGT device 202, such as the network interface 114 of the computer system 102 of FIG. 1, operatively couples and communicates between the STDGT device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the STDGT device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, computer readable media, and STDGT devices that efficiently implement a method for a Synthetic Training Data Generation Tool that rectifies deficiencies that exist within a training dataset.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The STDGT device 202 may be a standalone device or integrated with one or more other devices or apparatuses, such as one or more of the server devices 204(1)-204(n), for example. In one particular example, the STDGT device 202 may include or be hosted by one of the server devices 204(1)-204(n), and other arrangements are also possible. As another example, the STDGT device 202 may be integrated with one or more other devices or apparatuses, such as one or more of the client devices 208(1)-208(n). Moreover, one or more of the devices of the STDGT device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the STDGT device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the repositories and/or databases 206(1)-206(n) that are configured to store data that relates to a variety of repositories and/or databases.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the STDGT device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the STDGT device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the STDGT device 202, the server devices 204(1)-204(n), the repositories and/or databases 206(1)-206(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the STDGT device 202, the server devices 204(1)-204(n), the repositories and/or databases 206(1)-206(n), or the client devices 208(1)-208(n), for example, may be configured to operate as virtual instances on the same physical machine. In other words, one or more of the STDGT device 202, the server devices 204(1)-204(n), the repositories and/or databases 206(1)-206(n), or the client devices 208(1)-208(n) may operate on the same physical device rather than as separate devices communicating through communication network(s) 210. Additionally, there may be more or fewer STDGT devices 202, server devices 204(1)-204(n), repositories and/or databases 206(1)-206(n), or client devices 208(1)-208(n) than illustrated in FIG. 2.

In addition, two or more computing systems, databases or devices may be substituted for any one of the systems, databases or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

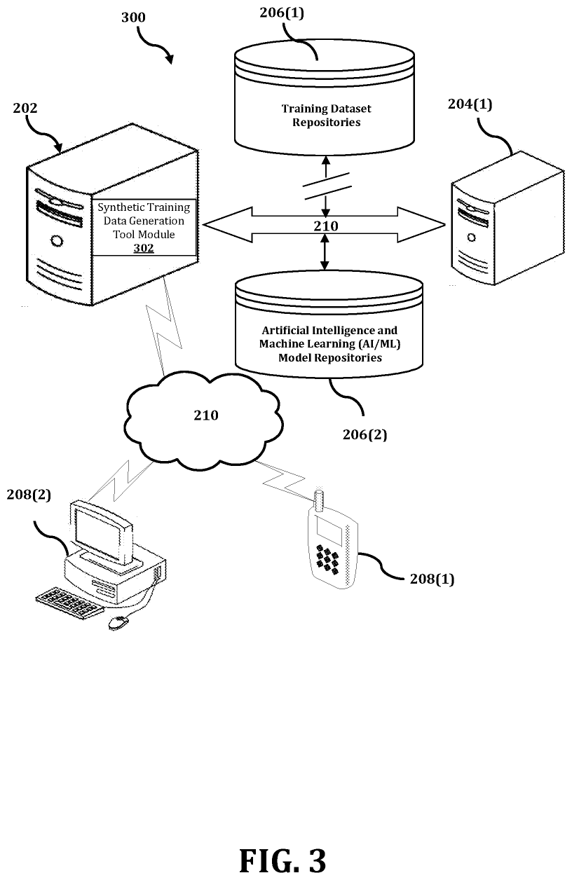

The STDGT device 202 is described and illustrated in FIG. 3 as including synthetic training data generation tool module 302, although it may include other rules, policies, modules, databases, or applications, for example. As will be described below, synthetic training data generation tool module 302 is configured to improve the efficiency of various intangible product production processes. Synthetic training data generation tool module 302 may include software that is based on a microservices architecture.

Synthetic training data generation tool module 302 may be integrated with one or more devices or apparatuses, such as client devices 208(1)-208(n), where synthetic training data generation tool module 302 may be implemented as an application or as an addon or plugin to another application of the one or more devices or apparatuses, and where synthetic training data generation tool module 302 may execute in the background.

An exemplary process 300 for application of a Synthetic Training Data Generation Tool to an aspect of the network environment of FIG. 2 is illustrated as being executed in FIG. 3. Specifically, a first client device 208(1) and a second client device 208(2) are illustrated as being in communication with STDGT device 202. In this regard, the first client device 208(1) and the second client device 208(2) may be “clients” of the STDGT device 202 and are described herein as such. Nevertheless, it is to be known and understood that the first client device 208(1) and/or the second client device 208(2) need not necessarily be “clients” of the STDGT device 202, or any entity described in association therewith herein. Any additional or alternative relationship may exist between either or both of first client device 208(1), second client device 208(2) and STDGT device 202, or no relationship may exist.

Further, STDGT device 202 is illustrated as being able to access training dataset repositories 206(1), and artificial intelligence and machine learning (AI/ML) model repositories 206(2). STDGT device 202 may comprise a Synthetic Training Data Generation Tool that communicates with training dataset repositories 206(1). In addition, the Synthetic Training Data Generation Tool of STDGT device 202 may also communicate with AI/ML model repositories 206(2). Synthetic training data generation tool module 302 may be configured to access these repositories and/or databases in order to rectify deficiencies that exist within a training dataset.

Moreover, STDGT device 202 may receive and transmit data via communication network(s) 210. STDGT device 202 may receive and transmit data such as code that is written in one or more of the following dialects: transaction control language (TCL), data manipulation language (DML), data control language (DCL) and data definition language (DFL).

Additionally, via communication network(s) 210, STDGT device 202 may respectively receive and transmit data from and to one or more of the following devices: server device 204(1), training dataset repositories 206(1), AI/ML model repositories 206(2), first client device 208(1), the second client device 208(2), and communication network(s) 210, for example.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The client devices 208(1)-208(n) may represent, for example, computer systems of an organization or database network. The first client device 208(1) represent, for example, one or more computer systems of a department or cluster within the organization or database network. Of course, the first client device 208(1) may include one or more of any of the devices described herein. The second client device 208(2) may be, for example, one or more computer systems of another department or cluster within the organization or database network. Of course, the second client device 208(2) may include one or more of any of the devices described herein.

The process may be executed via the communication network(s) 210, which may comprise plural networks as described above. For example, in an exemplary embodiment, either or both of the first client device 208(1) and the second client device 208(2) may communicate with the STDGT device 202 via broadband or cellular communication. Of course, these embodiments are merely exemplary and are not limiting or exhaustive.

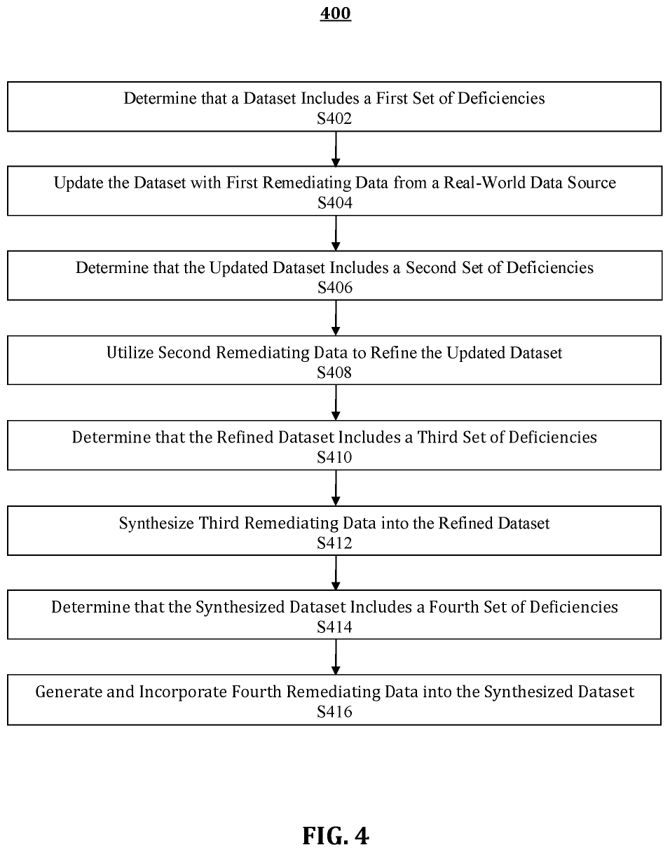

Synthetic training data generation tool module 302 may execute a process for removing deficiencies from a dataset that rectifies deficiencies that exist within a training dataset. An exemplary process for removing deficiencies from a dataset is generally indicated at flowchart 400 in FIG. 4.

Process 400 of FIG. 4 depicts a flowchart of a process that removes deficiencies from a first training dataset that has been obtained via an input of synthetic training data generation tool module 302. When process 400 begins, at step S402, synthetic training data generation tool module 302 determines that the first training dataset includes a first set of training deficiencies.

In an exemplary embodiment of the invention disclosed herein, the first set of training deficiencies may include, but is not limited to, at least one from among: a set of new training data, a set of incomplete training data, a set of missing training data, a set of irregular data, a set of training biases, and a set of unavailable hypothetical scenario data.

In an additional or alternative exemplary embodiment of the invention, the determination of step S402 may include, but is not limited to, evaluating at least one from among: the first training dataset; and a first artificial intelligence and machine learning (AI/ML) model that has been training according to the first training dataset.

Based on the first set of training deficiencies, after step S402, synthetic training data generation tool module 302 may search a first set of data sources for a first set of remediating data that rectifies at least a first deficiency from among the first set of training deficiencies. In an exemplary embodiment, the first set of data sources may comprise at least one from among a public and private data source of a communication network, such as the Internet and/or another communication network of communication network(s) 210. Additionally, or in an alternative exemplary embodiment, the first set of remediating data may comprise real-world data and/or the first set of data sources may comprise a live data feed, for example.

At step S404, synthetic training data generation tool module 302 rectifies the at least the first deficiency by combining the first training dataset with the first set of remediating data to produce a first updated training dataset. In an exemplary embodiment, the first updated training dataset may comprise the first training dataset and the first set of remediating data.

At step S406, synthetic training data generation tool module 302 determines that the updated dataset includes a second set of training deficiencies. In an exemplary embodiment, the second set of training deficiencies may comprise at least one from among: a first set of new deficiencies and a subset of the first set of training deficiencies.

Based on the second set of training deficiencies, after step S406, synthetic training data generation tool module 302 generates a second set of remediating data that rectifies at least a second deficiency from among the second set of training deficiencies. In an exemplary embodiment, synthetic training data generation tool module 302 generates the second set of remediating data by synthesizing the second set of remediating data. In a further embodiment, the synthesizing may comprise utilizing at least one from among: an interpolation and an extrapolation, to produce a first refined training dataset from the first updated training dataset.

At step S408, synthetic training data generation tool module 302 utilizes the second set of remediating data to refine the updated training dataset and, thereby, produce a first refined training dataset. In an exemplary embodiment, synthetic training data generation tool module may generate (or synthesize) the second set of remediating data and perform step S408 either simultaneously, or in that sequence. In an additional or alternative embodiment, the first refined training dataset may comprise: the first training dataset, the first set of remediating data, and the second set of remediating data.

At step S410, synthetic training data generation tool module 302 determines that the first refined training dataset includes a third set of training deficiencies. In an exemplary embodiment, the third set of training deficiencies may comprise at least one from among a second new set of deficiencies and a subset of the second set of training deficiencies.

Based on the third set of training deficiencies, after step S410, synthetic training data generation tool module 302 generates a third set of remediating data that rectifies at least a third deficiency from among the third set of training deficiencies. In an exemplary embodiment, synthetic training data generation tool module 302 may generate the third set of remediating data by mimicking a set of characteristics from a set of existing data. In a further embodiment, the set of characteristics may comprise at least one from among a set of values from the first training dataset, a set of statistical features of the first training dataset, and a distribution of the first training dataset.

In a further embodiment, the set of characteristics may comprise at least one from among: user selected characteristics, and characteristics of a similar dataset that has more attributes in common with the third remediating data than another available set of data has in common with the third remediating data. For example, a dataset of a particular demographic has more attributes in common with another demographic's dataset than it has in common with a dataset that tracks industrial trends or business objectives.

Accordingly, when the third set of remediating data to-be-generated pertains to a particular demographic, the third set of remediating data may be generated by populating, a set of fields of the third set of remediating data to-be-generated, with a set of values from another demographic's existing data. In an exemplary embodiment, the other demographic may be a demographic that has more attributes in common with a particular demographic of the third remediating data to-be-generated than another available demographic has in common with the particular demographic of the third remediating data to-be-generated.

In an embodiment, although the similarity between the similar dataset and the third set of remediating data to-be-generated may be based on a particular demographic (as mentioned above), additionally or alternatively, the similarity between the similar dataset and the third set of remediating data to-be-generated may also be based on any other subject matter as well (such as at least one from among a particular trend, financial instrument, business entity, network resource, etc.).

At step S412, synthetic training data generation tool module 302 synthesizes the third set of remediating data into the first refined training dataset. In an embodiment, synthetic training data generation tool module 302 may synthesize the third set of remediating data into the first refined training dataset by populating a set of fields of the first refined training dataset with values of the third set of remediating data. In an exemplary embodiment, synthetic training data generation tool module 302 may generate a first synthesized training dataset by synthesizing the third set of remediating data into the first refined training dataset. In an additional or alternative embodiment, the first synthesized training dataset may comprise: the first training dataset, the first set of remediating data, the second set of remediating data, and the third set of remediating data.

At step S414, synthetic training data generation tool module 302 determines that the first synthesized training dataset includes a fourth set of training deficiencies. In an exemplary embodiment, the fourth set of training deficiencies may comprise at least one from among: a third set of new deficiencies and a third set of deficiencies from among the third set of training deficiencies.

Based on the fourth set of training deficiencies, at step S416, synthetic training data generation tool module 302 generates a fourth set of remediating data that rectifies at least a fourth deficiency from among the fourth set of training deficiencies. In an exemplary embodiment, synthetic training data generation tool module 302 may generate the fourth set of remediating data by utilizing at least one from among: a random number generator; user settings; and a second AI/ML model, to produce the fourth remediating data.

Additionally, at step S416, synthetic training data generation tool module 302 utilizes the fourth remediating data to rectify the at least the fourth deficiency. At step S416, synthetic training data generation tool module 302 rectifies the at least the fourth deficiency by incorporating the fourth remediating data into the first synthesized training dataset. In an exemplary embodiment, at step S416, synthetic training data generation tool module 302 may produce a second synthesized training dataset by incorporating the fourth remediating data into the first synthesized training dataset. In a further embodiment, the second synthesized training dataset may comprise the first synthesized training dataset and the fourth remediating data.

In an exemplary embodiment, after step S416, process 400 may conclude (i.e., end or terminate) if synthetic training data generation tool module 302 determines that the second synthesized training dataset is free of deficiencies. In other words, once synthetic training data generation tool module 302 determines that the second synthesized training dataset does not include any deficiencies, then process 400 may conclude after step S416.

In an alternative embodiment, after step S416, synthetic training data generation tool module 302 may determine that the second synthesized training dataset comprises a fifth set of training deficiencies. In a further embodiment, based on the fifth set of training deficiencies, synthetic training data generation tool module 302 may continuously repeat set S416 to produce a subsequent synthesized training dataset until synthetic training data generation tool module 302 determines that the subsequent synthesized training dataset is free of deficiencies.

In another exemplary embodiment, process 400 may conclude (i.e., end or terminate) whenever synthetic training data generation tool module 302 determines that a particular dataset of training data (e.g., the updated dataset, the refined dataset, the first synthesized dataset, etc.) does not include a deficiency. For example, in an exemplary embodiment, process 400 may conclude (i.e., end or terminate), after one from among steps S406, S410, and S414, if synthetic training data generation tool module 302 determines that no deficiency is present in one from among the updated dataset, the refined dataset, and the first synthesized dataset, respectively.

In an exemplary embodiment, after process 400 concludes (i.e., end or terminate), synthetic training data generation tool module 302 may repeat process 400 to remove one or more deficiencies from a subsequent (e.g., a second) training dataset. In a further embodiment, synthetic training data generation tool module 302 may continuously monitor the input of synthetic training data generation tool module 302 to identify any subsequent dataset(s) that include(s) a fifth set of training deficiencies. Additionally, in this further embodiment, upon identifying the fifth set of training deficiencies, synthetic training data generation tool module 302 may repeat process 400 in order to remove the fifth set of training deficiencies from the subsequent dataset(s).

In an alternative or additional embodiment, after process 400 concludes (i.e., end or terminate), synthetic training data generation tool module 302 may train a third AI/ML model by utilizing at least one from among: the first training dataset, the first updated training dataset, the first refined training dataset; the first synthesized training dataset, and the second synthesized training dataset. Additionally, in this embodiment, after training the third AI/ML model, synthetic training data generation tool module 302 may evaluate the third AI/ML model to identify a sixth set of training deficiencies. Moreover, in this exemplary embodiment, upon identifying the sixth set of training deficiencies, synthetic training data generation tool module 302 may repeat process 400 in order to remove the sixth set of training deficiencies from the at least one from among the first training dataset, the first updated training dataset, the first refined training dataset, the first synthesized training dataset, and the second synthesized training dataset.

Accordingly, process 400 of FIG. 4 may be utilized by synthetic training data generation tool module 302 to remove at least one deficiency from a training dataset by tuning the training dataset according to an AI/ML model to which the training dataset pertains.

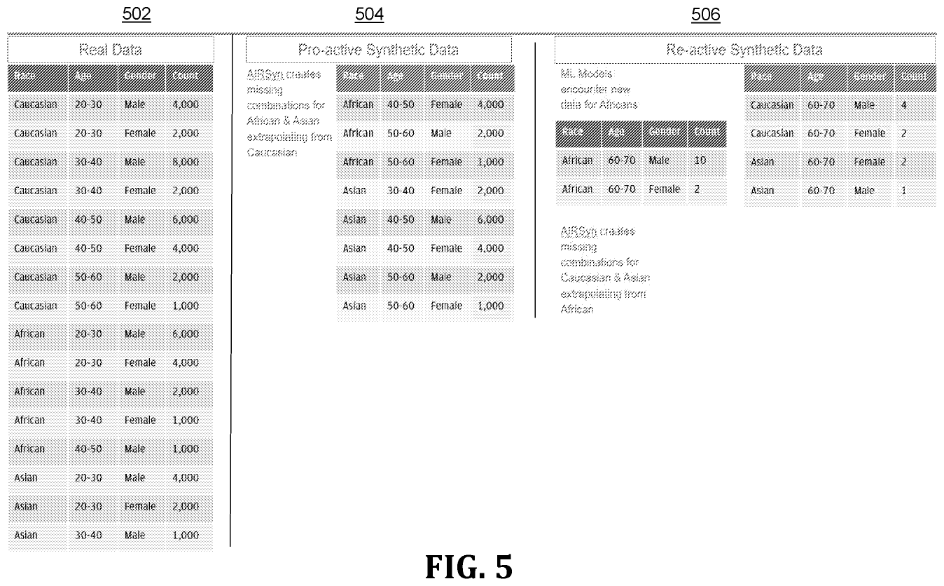

FIG. 5 depicts tables 500, which are each populated with characteristics (such as “values” and “attributes”) of distinct sets of training data. As illustrated in FIG. 5, tables 500 comprise training dataset 502 and a pair of remediating datasets that each rectify at least one deficiency that exists within a dataset (such as “training dataset 502”), and the pair of remediating datasets includes pro-active synthetic data 504 and re-active synthetic data 506. Although a training dataset may pertain to any subject matter, training dataset 502 depicted in FIG. 5 pertains to demographic information. In an exemplary embodiment, synthetic training data generation tool module 302 generates a remediating dataset in response to discovering that a dataset-under-evaluation (such as “training dataset 502”) comprises one or more identified deficiencies (such as at least one from among the above-mentioned sets of training deficiencies).

In this exemplary embodiment, pro-active synthetic data 504 is generated by synthetic training data generation tool module 302 in response to determining that the dataset-under-evaluation does not include a value for one or more relevant combinations of attributes for a particular subject matter (e.g., determining that training dataset 502 is missing combinations for Black and Asian demographics). Although synthetic training data generation tool module 302 may utilize any of the above-mentioned techniques (such as the refining and synthesizing functions of steps S408, S412 and S416, for example) to generate a remediating dataset, as illustrated in FIG. 5, its pro-active synthetic data 504 is produced by synthesizing data for missing combinations by extrapolating such data from the Caucasian demographic of training dataset 502 in order to generate necessary data for the missing combinations from the Black and Asian demographics of training dataset 502.

In this exemplary embodiment, re-active synthetic data 506 is generated by synthetic training data generation tool module 302 in response to determining that it has encountered data for a new combination (or a new subject matter, such as a new demographic) of a dataset-under-evaluation (e.g., determining that training dataset 502 is missing combinations for Asian and Caucasian demographics). Although synthetic training data generation tool module 302 may utilize any of the above-mentioned techniques (such as the refining and synthesizing functions of steps S408, S412 and S416, for example) to generate a remediating dataset, as illustrated in FIG. 5, its re-active synthetic data 506 is produced by synthesizing data for missing combinations by extrapolating such data from the Black demographic of training dataset 502 in order to generate necessary data for the missing combinations from the Asian and Caucasian demographics of training dataset 502.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems.

Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for removing deficiencies from a dataset, the method comprising:
obtaining, via an input of the synthetic training data generation tool, a first training dataset; and
removing deficiencies from the first training dataset, wherein the removing the deficiencies comprises:
determining that the first training dataset includes a first set of training deficiencies;
retrieving, from at least one data source, first remediating data that rectifies a first deficiency from among the first set of training deficiencies, wherein the first remediating data comprises real-world data;
rectifying the first deficiency by combining the first training dataset with the first remediating data to produce a first updated training dataset that comprises the first training dataset and the first remediating data;
determining that the first updated training dataset includes a second set of training deficiencies; and
synthesizing second remediating data that rectifies a second deficiency from the second set of training deficiencies.

2. The method of claim 1, wherein the first set of training deficiencies comprises at least one from among a set of new training data, a set of incomplete training data, a set of missing training data, a set of irregular data, a set of training biases, and a set of unavailable hypothetical scenario data.

3. The method of claim 1, wherein the synthesizing comprises utilizing at least one from among an interpolation and an extrapolation to produce a first refined training dataset from the first updated training dataset, and wherein the first refined training dataset comprises the first training dataset, the first remediating data, and the second remediating data.

4. The method of claim 3, wherein the removing the deficiencies further comprises:
determining that the first refined training dataset includes a third set of training deficiencies;
generating third remediating data that rectifies a third deficiency from the third set of training deficiencies; and
rectifying the third deficiency by integrating the third remediating data into the first refined training dataset to produce a first synthesized training dataset that comprises the first refined training dataset and the third remediating data.

5. The method of claim 4, wherein the generating the third remediating data comprises: mimicking a set of characteristics from a set of existing data, wherein the set of characteristics comprises at least one from among: user selected characteristics; and characteristics of a similar dataset that has more attributes in common with the third remediating data than another available set of data has in common with the third remediating data.

6. The method of claim 5, wherein the set of characteristics comprises at least one from among a set of values from the first training dataset, a set of statistical features of the first training dataset, and a distribution of the first training dataset.

7. The method of claim 5, wherein the removing the deficiencies further comprises:
determining that the first synthesized training dataset includes a fourth set of training deficiencies;
generating fourth remediating data that rectifies a fourth deficiency from the fourth set of training deficiencies; and
rectifying the fourth deficiency by integrating the fourth remediating data into the first synthesized training dataset to produce a second synthesized training dataset that comprises the first synthesized training dataset and the fourth remediating data.

8. The method of claim 7, further comprising:
utilizing at least one from among the first training dataset, the first updated training dataset, the first refined training dataset, the first synthesized training dataset, and the second synthesized training dataset, to train a first artificial intelligence and machine learning (AI/ML) model;
evaluating the first AI/ML model to identify a fifth set of training deficiencies from a first performance of the first AI/ML model; and
upon identifying the fifth set of training deficiencies, repeating the removing the deficiencies in order to remove the fifth set of training deficiencies from the at least one from among the first training dataset, the first updated training dataset, the first refined training dataset, the first synthesized training dataset, and the second synthesized training dataset.

9. The method of claim 7, wherein the generating the fourth remediating data comprises:
utilizing at least one from among: a random number generator; user settings; and a second AI/ML model, to produce the fourth remediating data.

10. The method of claim 9, further comprising:
continuously monitoring the input to identify a subsequent dataset that includes a sixth set of training deficiencies; and
upon identifying the subsequent dataset, repeating the removing the deficiencies in order to remove the sixth set of training deficiencies from the subsequent dataset.

11. A system for removing deficiencies from a dataset, the system comprising:
a processor; and
memory storing instructions that, when executed by the processor, cause the processor to perform operations comprising:
obtaining, via an input of the synthetic training data generation tool, a first training dataset; and
removing deficiencies from the first training dataset, wherein the removing the deficiencies comprises:
determining that the first training dataset includes a first set of training deficiencies;
retrieving, from at least one data source, first remediating data that rectifies a first deficiency from among the first set of training deficiencies, wherein the first remediating data comprises real-world data;
rectifying the first deficiency by combining the first training dataset with the first remediating data to produce a first updated training dataset that comprises the first training dataset and the first remediating data;
determining that the first updated training dataset includes a second set of training deficiencies; and
synthesizing second remediating data that rectifies a second deficiency from the second set of training deficiencies.

12. The system of claim 11, wherein the synthesizing comprises utilizing at least one from among an interpolation and an extrapolation to produce a first refined training dataset from the first updated training dataset, and wherein the first refined training dataset comprises the first training dataset, the first remediating data, and the second remediating data.

13. The system of claim 12, wherein the removing the deficiencies further comprises:
determining that the first refined training dataset includes a third set of training deficiencies;
generating third remediating data that rectifies a third deficiency from the third set of training deficiencies; and
rectifying the third deficiency by integrating the third remediating data into the first refined training dataset to produce a first synthesized training dataset that comprises the first refined training dataset and the third remediating data.

14. The system of claim 13, wherein the generating the third remediating data comprises:
mimicking a set of characteristics from a set of existing data, wherein the set of characteristics comprises at least one from among: user selected characteristics; and characteristics of a similar dataset that has more attributes in common with the third remediating data than another available set of data has in common with the third remediating data.

15. The system of claim 14, wherein the removing the deficiencies further comprises:
determining that the first synthesized training dataset includes a fourth set of training deficiencies;
generating fourth remediating data that rectifies a fourth deficiency from the fourth set of training deficiencies; and
rectifying the fourth deficiency by integrating the fourth remediating data into the first synthesized training dataset to produce a second synthesized training dataset that comprises the first synthesized training dataset and the fourth remediating data.

16. The system of claim 15, wherein the generating the fourth remediating data comprises: utilizing at least one from among: a random number generator; user settings; and a second AI/ML model, to produce the fourth remediating data.

17. The system of claim 16, wherein the instructions when executed, cause the processor to perform further operations comprising:
continuously monitoring the input to identify a subsequent dataset that includes a fifth set of training deficiencies; and
upon identifying the subsequent dataset, repeating the removing the deficiencies in order to remove the fifth set of training deficiencies from the subsequent dataset.

18. A non-transitory computer-readable medium for removing deficiencies from a dataset, the computer-readable medium storing instructions that, when executed by a processor, cause the processor to perform operations comprising:
obtaining, via an input of the synthetic training data generation tool, a first training dataset; and
removing deficiencies from the first training dataset, wherein the removing the deficiencies comprises:
determining that the first training dataset includes a first set of training deficiencies;
retrieving, from at least one data source, first remediating data that rectifies a first deficiency from among the first set of training deficiencies, wherein the first remediating data comprises real-world data;
rectifying the first deficiency by combining the first training dataset with the first remediating data to produce a first updated training dataset that comprises the first training dataset and the first remediating data;
determining that the first updated training dataset includes a second set of training deficiencies; and
synthesizing second remediating data that rectifies a second deficiency from the second set of training deficiencies.

19. The computer-readable medium of claim 18, wherein the synthesizing comprises utilizing at least one from among an interpolation and an extrapolation to produce a first refined training dataset from the first updated training dataset, and wherein the first refined training dataset comprises the first training dataset, the first remediating data, and the second remediating data.

20. The computer-readable medium of claim 19, wherein the removing the deficiencies further comprises:
determining that the first refined training dataset includes a third set of training deficiencies;
generating third remediating data that rectifies a third deficiency from the third set of training deficiencies; and
rectifying the third deficiency by integrating the third remediating data into the first refined training dataset to produce a first synthesized training dataset that comprises the first refined training dataset and the third remediating data.
